(19) United States
(12) Patent Application Publication
(10) Pub. No.: US 2014/0089817 A1
(43) Pub. Date: Mar. 27, 2014

(54) DISTRIBUTED SYSTEMS AND METHODS FOR COLLABORATIVE CREATION AND MODIFICATION OF GEOMETRIC MODELS

(71) Applicant: SIEMENS PRODUCT LIFECYCLE MANAGEMENT SOFTWARE, Plano, TX (US)

(72) Inventors: Jinendra Bansilal Akkarbote, Pune (IN); Avijit Sen, Cypress, CA (US); Nilesh Madhav Rajhans, Pune (IN); Suzith Annam, Pune (IN)

(73) Assignee: SIEMENS PRODUCT LIFECYCLE MANAGEMENT SOFTWARE INC., Plano, TX (US)

(21) Appl. No.: 13/629,025

(22) Filed: Sep. 27, 2012

(51) Int. Cl. G06F 3/048

(52) U.S. Cl. 715/753

(57) ABSTRACT

Distributed systems and methods for allowing multiple users at separate workstations to collaboratively create and modify a geometric model of an object. According to embodiments, a system includes program code to generate the geometric model of an object at a first workstation and to store a first data representing the geometric model. The system also includes program code to transmit a duplicate copy and modification commands to a second workstation. The system also includes program code to receive a modified duplicate copy of the first data from the second workstation and to combine the first data and the modified duplicate copy of the first data to generate a modified geometric model of the object.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or “PDM” systems).

### BACKGROUND OF THE DISCLOSURE

PDM systems manage PLM and other data. Improved systems are desirable.

### SUMMARY OF THE DISCLOSURE

Various disclosed embodiments include distributed systems and methods for allowing multiple users at separate workstations to collaboratively create and modify a geometric model of an object. The system includes program code to generate the geometric model of an object at a first workstation and to store a first data representing the geometric model at the first workstation. The system also includes program code to generate a duplicate copy of the first data at the first workstation and to generate modification commands at the first workstation specifying portions of the first data to be modified by the second workstation. The modification commands specify modifications to be made by the second workstation so as to maintain a consistent representation of the geometric model. The system also includes program code to transmit via the communication network the duplicate copy and the commands to the second workstation and to receive the modified duplicate copy of the first data from the second workstation. The system also includes program code to combine the first data and the modified duplicate copy of the first data to generate a modified geometric model of the object.

According to embodiments, a method for allowing multiple users to collaboratively create and modify a geometric model of an object from separate workstations linked via a communication network includes generating the geometric model of an object at a first workstation and storing a first data representing the geometric model at the first workstation. The method also includes generating a duplicate copy of the first data at the first workstation. The method also includes generating modification commands at the first workstation specifying portions of the first data to be modified by the second workstation. The modification commands specify modifications so as to maintain a consistent representation of the geometric model. The method also includes transmitting via the communication network the duplicate copy and the modification commands to the second workstation. The method also includes receiving the modified duplicate copy of the first data from the second workstation, and combining the first data and the modified duplicate copy of the first data to generate a modified geometric model.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a computer system in accordance with disclosed embodiments;

FIG. 2 illustrates a distributed system in accordance with disclosed embodiments;

FIG. 3 illustrates a workflow in accordance with disclosed embodiments;

FIGS. 4 and 5 depict processes in accordance with disclosed embodiments; and

FIG. 6 illustrates a cloud computing system in accordance with disclosed embodiments.

### DETAILED DESCRIPTION

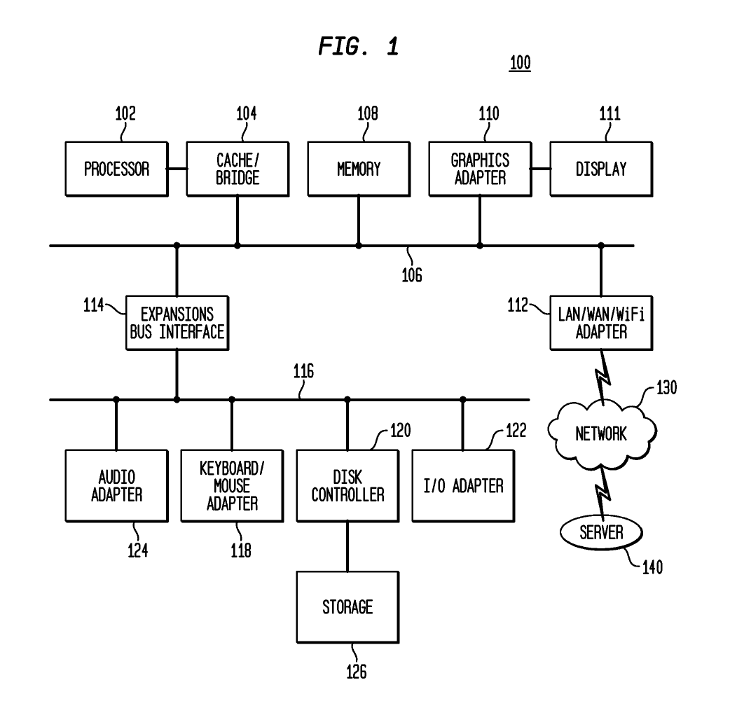

FIGS. 1 through 6, discussed below, and the various embodiments used to describe the principles of the present disclosure in this patent document are by way of illustration only and should not be construed in any way to limit the scope of the disclosure. Those skilled in the art will recognize that the principles of the present disclosure may be implemented in any suitably arranged device or a system. The numerous innovative teachings of the present application will be described with reference to exemplary non-limiting embodiments.

PDM systems are widely used by designers and engineers in design, development, and modification of products and systems. PDM systems allow designers and engineers to develop and test products in a virtual environment prior to building actual prototypes. Advances in PDM technology allows designers at separate locations to collaborate in the design and development of a product. For example, in automotive design, a lead designer using a PDM system may create a model of a door panel of an automobile. The lead designer may electronically transmit the model to a second designer with instructions to create holes and cutouts in the door panel. The second designer may modify the model in accordance with the instructions and then forward the modified model to a third designer with instructions to apply edge bends to the model.

In a globalized market, companies frequently compete to release new products and to release upgrades of existing products. Thus, companies remain under pressure to lessen their product development lifecycles in order to speed up the introduction of new products and upgrades of existing products. Currently available PDM systems generally do not allow a model of an object such as a part to be distributed to multiple designers in a manner to allow the designers to separately work on the same model, which would lessen a product's development lifecycle. Although some currently available PDM systems allow a lead designer to split a model and forward the split models to separate designers for modifications, the PDM systems do not allow multiple designers at separate locations to modify the same model.

Various disclosed embodiments provide distributed systems and methods for allowing multiple users at separate workstations linked via a communication network to collaboratively create and modify a geometric model of an object. The disclosed embodiments provide a collaborative design environment, which allows a lead designer to create a geometric model of an object, which may be distributed to other designers at separate workstations for modification.

FIG. 1 depicts a block diagram of a data processing system 100 in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

The data processing system 100 in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

A LAN/WAN/Wireless adapter 112 can be connected to a network 130 (not a part of data processing system 100), which can be any public or private data processing system network or combination of networks, as known to those of skill in the art, including the Internet. The data processing system 100 can communicate over a network 130 with a server system 140, which is also not part of the data processing system 100, but can be implemented, for example, as a separate data processing system 100. The data processing system 100 may be configured as a workstation, and a plurality of similar workstations may be linked via a communication network to form a distributed system in accordance with embodiments of the disclosure.

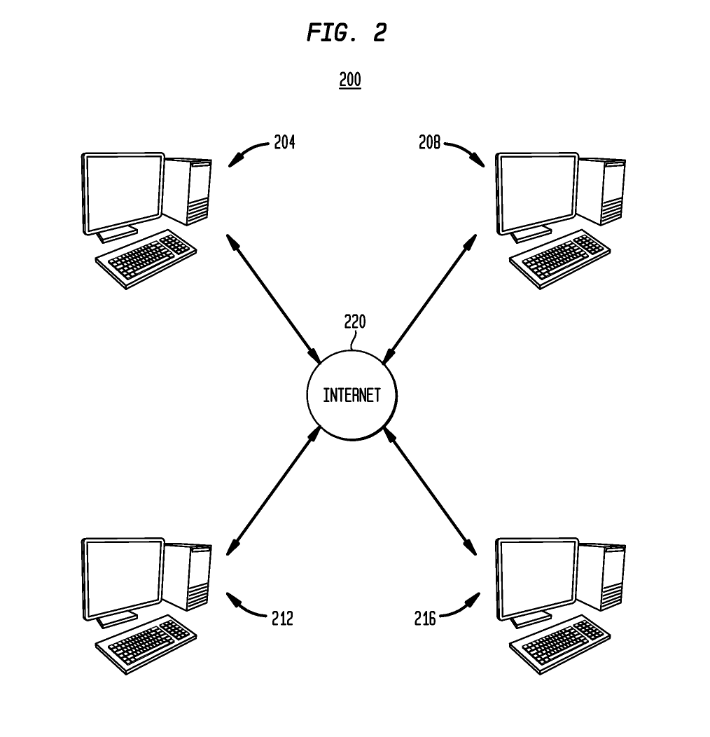

FIG. 2 illustrates a system 200, which includes a plurality of workstations 204, 208, 212, and 216 linked via a communication network such as the Internet 220. The system 200 creates a collaborative design environment, which allows multiple users to create and modify a geometric model of an object from the workstations 204, 208, 212, and 216. Each of the workstations depicted here can be implemented, for example, as one or more data processing systems 100.

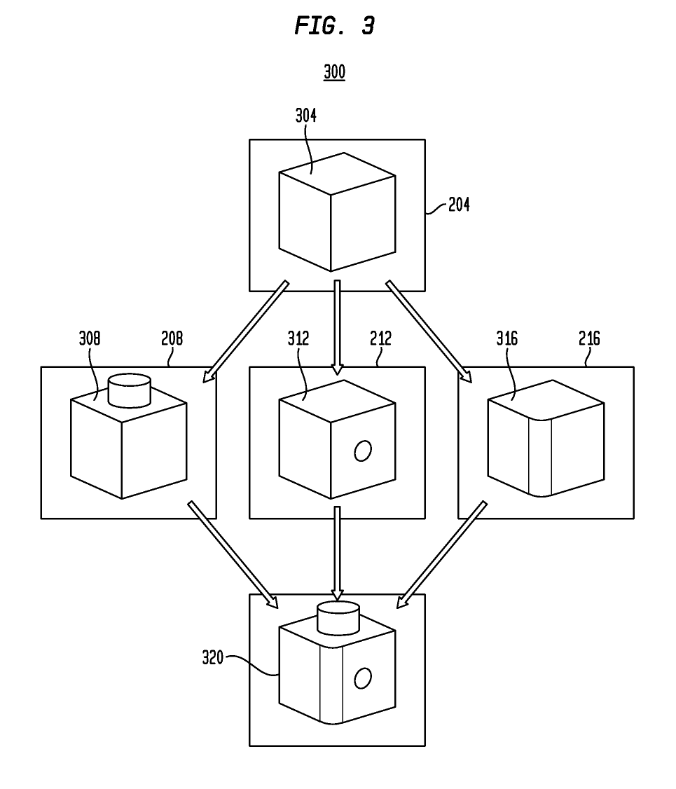

FIG. 3 illustrates a workflow 300 which allows multiple users to collaboratively create and modify a geometric model of an object from separate workstations. A lead designer at the workstation 204 creates a geometric model of a main body part 304. Alternatively, the lead designer may open an existing geometric model such as, for example, the main body part 304, which may have been previously created and stored.

The lead designer at the workstation 204 distributes the main body part 304 to the designers at the workstations 208, 212, and 216 to enable each designer at the workstations 208, 212, and 216 to modify the main body part 304. According to some embodiments, the lead designer may distribute the main body part 304 to the designers at the workstations 208, 212, and 216 with specific instructions for each designer at the workstations 208, 212, and 216 to modify the main body part 304. Alternatively, the lead designer may distribute the main body part 304 to the designers at the workstations 208, 212, and 216 without any instructions and allow the designers at the workstations 208, 212, and 216 to independently modify the main body part 304. The designers at the workstations 208, 212, and 216 may be able to modify the part independently without any specific instructions if each designer, for example, has an assigned area of responsibility.

Referring again to FIG. 3, the lead designer distributes the main body part 304 to the designers at the workstations 208, 212 and 216 with specific instructions for each designer at the workstations 208, 212 and 216 to modify the main body part 304. The instructions may, for example, require the designer at the workstation 208 to apply a boss feature on the top face of the main body part 304, require the designer at the workstation 212 to apply a hole on a side face of the main body part 304, and require the designer at the workstation 216 to apply an edge bend on a vertical edge of the main body part 304. The lead designer at the workstation 204 creates three copies (i.e., duplicate copies) of the main body part 304, designated as a linked part 308, a linked part 312, and a linked part 316 and distributes the linked part 308, the linked part 312 and the linked part 316 to the workstations 208, 212 and 216, respectively.

In accordance with the instructions, the designer at the workstation 208 applies a boss feature on the linked part 308, the designer at the workstation 212 applies a hole on the linked part 312, and the designer at the workstation 216 applies an edge bend on the linked part 316. The three modified main body parts are then combined with the main body part 304 to modify the body part 304, which is depicted by reference numeral 320. Note that while the original body part 304 and the modified body part 320 are shown separately here for clarity of illustration, in many implementations the original body part 304 is simply modified and stored, without necessarily creating a separate modified body part 320.

According to various embodiments, the three modified body parts may be transmitted back to the workstation 204 where they are combined with the main body part 304 to modify the main body part 304. It will be apparent to those skilled in the art that the geometric model of an object may be initially created or originated at any one of the workstations 204, 208, 212, and 216, and the model may be distributed to the other workstations for modifications. Likewise, it will be apparent to those skilled in the art that the modified models may be combined at the workstation from where geometric model was initially created or originated.

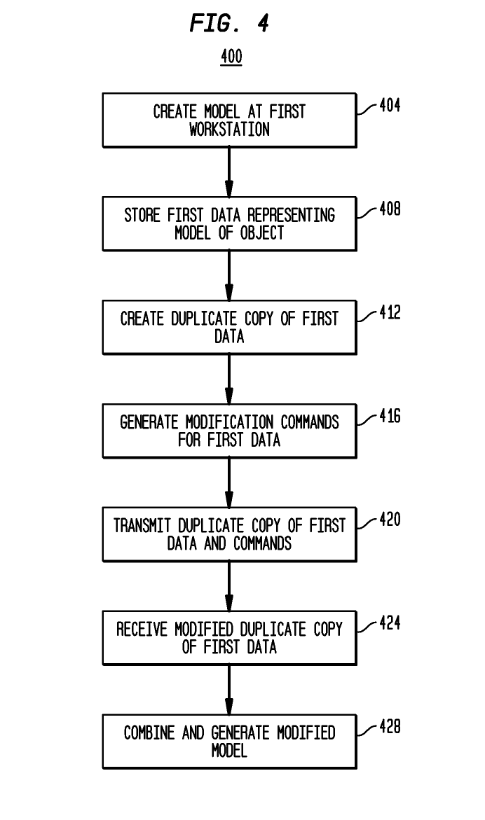

FIG. 4 is a flowchart of a process 400 for allowing multiple users to collaboratively create and modify a geometric model of an object from a plurality of workstations (e.g., first and second workstations) linked via a communication network in accordance with disclosed embodiments. Such a process can be performed, for example, by a system 200 as described above, but the “system” in the process below can be any apparatus configured to perform a process as described. The “second workstation” may be a single workstation or a plurality of workstations (e.g., second—N workstations) linked via a communication network.

In a block 404, the first workstation (i.e., a designer working at the first workstation) creates a geometric model of an object. In a block 408, the first workstation stores a first data representing the geometric model. In a block 412, the first workstation creates a duplicate copy of the first data.

In a block 416, the first workstation generates modification commands specifying portions of the first data to be modified by the second workstation. The modification commands specify modifications so as to maintain a consistent representation of the geometric model by the first data and by the duplicate copy of the first data. Thus, modifications made by one workstation must not be inconsistent with other modifications. By way of example, if a modification command instructs a workstation to apply a boss feature on the top face of a geometric model and another modification command instructs another workstation to apply a hole on the same location on the top face of the geometric model, the two modification commands cannot maintain a consistent representation of the geometric model, and thus the two modification commands are inconsistent with one another.

In a block 420, the first workstation transmits via the communication network the duplicate copy of the first data and the modification commands to the second workstation. The geometric model is modified by the second workstation in accordance with the modification commands to effect change to the model. Consequently, the duplicate copy of the first data representing the geometric model is modified by the second workstation. It will be apparent to those skilled in the art that the first workstation may transmit the duplicate copy of the first data to the second workstation without any modification commands if the designer at the second workstation has an assigned area of responsibility.

In a block 424, the first workstation receives the modified duplicate copy of the first data from the second workstation. In a block 428, the first workstation combines the first data and the modified duplicate copy of the first data to generate a modified geometric model of the object. According to embodiments, the first data and the modified duplicate copy of the first data are combined by program code. For example, the first data and the modified duplicate copy of the first data may be combined by a special program code, wherein an output is TRUE if at least one of the inputs is TRUE. That is, a feature is placed in the modified geometric model if it is TRUE that the feature exists in either the first data or in any one of the duplicate copies. It will be apparent to those skilled in the art that the first data and the modified duplicate copy may be combined using other methods well known in the art.

According to embodiments, the first workstation may create a first data file containing the first data representing the geometric model of an object. Also, the first workstation may create an output file containing a duplicate copy of the first data and may also create an input file for a modified duplicate copy of the first data. The first workstation may transmit the output file to the second workstation with commands specifying the modifications to be made. The second workstation may then store the modified duplicate copy of the first data in the input file. The first workstation may then combine the modified duplicate copy of the first data with the first data to create a modified geometric model in accordance with the foregoing process.

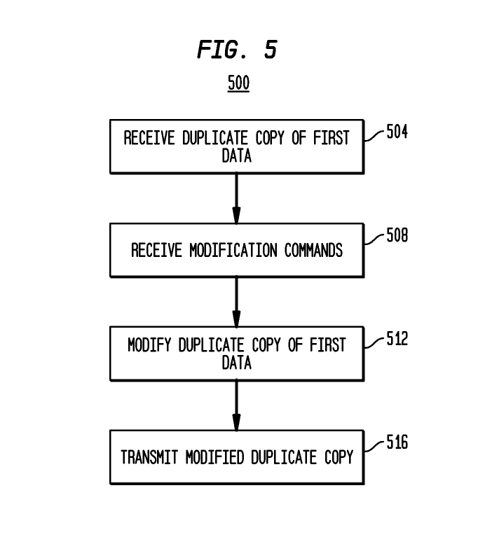

FIG. 5 is a flowchart of a process 500 for allowing a workstation to receive and modify a geometric model of an object. As discussed before, initially the first workstation creates a geometric model of an object and stores a first data representing the geometric model. The first workstation then transmits a duplicate copy of the first data to the second workstation. As discussed before, the “second workstation” may be a single workstation or may be a plurality of workstations (e.g., second—N workstations) linked via a communication network.

In a block 504, the second workstation receives the duplicate copy of a first data. In a block 508, the second workstation receives modification commands from the first workstation, if such commands are used. The modification commands specify modifications so as to maintain a consistent representation of the geometric model. It will be appreciated that the duplicate copy of the first data and the modification commands may be transmitted separately or together.

In a block 512, the second workstation modifies the duplicate copy of the first data in accordance with any modification commands to effect change to the geometric model. In a block 516, the second workstation transmits the modified duplicate copy of the first data back to the first workstation. As discussed before, the first workstation then combines the modified duplicate copy of the first data and the first data to create a modified geometric model.

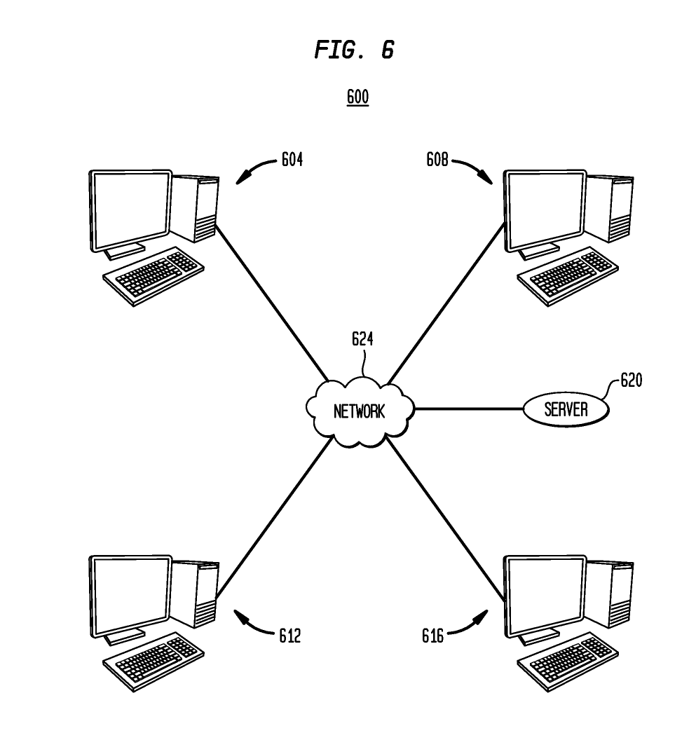

FIG. 6 illustrates a cloud computing system 600 according to disclosed embodiments. The system 600 includes a plurality of workstations 604, 608, 612, and 616 linked to a server 620 via a communication network such as the Internet 624. The server 620 may be used as a PDM system, which enables the workstations 604, 608, 612, and 616 to collaboratively create and modify a geometric model of an object. By way of example, the workstation 604 may create a model of an object which is stored in the server 620. The workstations 608-616 may access the server 620 to make modifications to the geometric model in accordance with aforementioned process and store the modified copies in the server 620. The modified copies may then be combined by the server 620 (or alternatively by any one of the workstations 604, 608, 612, and 616) to create a modified model of the object.

According to embodiments, a computer program product includes a non-transitory computer-readable medium having program logic recorded thereon for allowing multiple users to collaborate and to create and modify a geometric model of an object from separate workstations linked via a communication network. The computer program product includes code operable to generate the geometric model of an object at a first workstation and to store a first data representing the geometric model at the first workstation. The computer program product also includes code operable to generate a duplicate copy of the first data at the first workstation. The computer program product can also include code operable to generate modification commands at the first workstation specifying portions of the first data to be modified by a second workstation. The modification commands specify modifications so as to maintain a consistent representation of the geometric model. The computer program product also includes code operable to transmit via the communication network the duplicate copy and the commands to the second workstation. The computer program product also includes code operable to receive the modified duplicate copy of the first data from the second workstation and code operable to combine the first data and the modified duplicate copy to generate a modified geometric model of the object.

According to embodiments, a computer program product includes a non-transitory computer-readable medium having program logic recorded thereon for allowing multiple users at separate workstations to receive a geometric model of an object and to simultaneously modify the geometric model. The computer program product includes code operable to receive, by at least one of the workstations, a duplicate copy of a first data representing the geometric model of an object. The computer program product also includes code operable to receive, by at least one of the workstations, modification commands specifying portions of the first data to be modified by the receiving workstation. The computer program product also includes code operable to modify, by at least one of the workstations, the duplicate copy of the first data in accordance with the modification commands to effect change to the geometric model. The computer program product also includes code operable to transmit, by at least one of the workstations, the modified duplicate copy of the first data.

According to disclosed embodiments, a system allows a first workstation to create a geometric model of an object and a second workstation to modify the geometric model. The system includes program code to configure the workstations to receive by the second workstation a duplicate copy of a first data representing the geometric model of an object and to receive by the second workstation modification commands specifying portions of the first data to be modified by the second workstation, the modification commands specifying modifications so as to maintain a consistent representation of the geometric model. The system includes program code to modify the duplicate copy of the first data by the second workstation in accordance with the modification commands to effect change to the geometric model and to transmit by the second workstation via the communication network the modified duplicate copy of the first data.

According to disclosed embodiments, a method for allowing a first workstation to create a geometric model of an object and a second workstation to modify the geometric model includes receiving, by the second workstation, via a communication network a duplicate copy of a first data representing the geometric model of an object. The method includes receiving, by the second workstation modification commands specifying portions of the first data to be modified by the second workstation, the modification commands specifying modifications so as to maintain a consistent representation of the geometric model. The method includes modifying, by the second workstation, the duplicate copy of the first data in accordance with the modification commands to effect change to the geometric model and transmitting, by the second workstation the modified duplicate copy of the first data.

According to disclosed embodiments, a system allows a first workstation to create and store a geometric model of an object at a server and a second workstation to access the server to make modifications to the geometric model. The system includes program code to configure the workstations to access by the second workstation a duplicate copy of a first data at the server, the first data representing the geometric model of an object. The system includes program code to receive by the second workstation modification commands specifying portions of the first data to be modified by the second workstation, the modification commands being stored at the server and specifying modifications so as to maintain a consistent representation of the geometric model. The system includes program code to modify the duplicate copy of the first data by the second workstation in accordance with the modification commands to effect change to the geometric model and to store by the second workstation the modified duplicate copy of the first data at the server.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A data processing system for allowing multiple users to collaboratively create and modify a geometric model of an object from separate workstations linked via a communication network, comprising:
at least one processor;
an accessible memory; and
a network adapter connected to communicate with the communication network, the data processing system configured to
generate the geometric model of an object;
store a first data representing the geometric model;
generate a duplicate copy of the first data;
generate modification commands specifying portions of the first data to be modified by a second workstation, the modification commands specifying modifications so as to maintain a consistent representation of the geometric model;
transmit via the communication network the duplicate copy and the commands to the second workstation;
receive the modified duplicate copy of the first data from the second workstation; and
combine the first data and the modified duplicate copy of the first data to generate a modified geometric model of the object.

2. The data processing system of claim 1, wherein the duplicate copy of the first data is modified by the second workstation in accordance with the modification commands so as to maintain a consistent representation of the geometric model by the first data and by the modified duplicate copy of the first data.

3. The data processing system of claim 1, wherein the data processing system also creates a first data file containing the first data.

4. The data processing system of claim 1, wherein the data processing system also creates an output file containing the duplicate copy of the first data.

5. The data processing system of claim 4, wherein the data processing system also transmits the output file to the second workstation.

6. The data processing system of claim 1, wherein the data processing system also reads an input file containing the modified duplicate copy of the first data.

7. The data processing system of claim 6, wherein the data processing system also stores modifications made by the second workstation to the duplicate copy of the first data in the input file.

8. A method for allowing multiple users to collaboratively create and modify a geometric model of an object from separate workstations linked via a communication network, comprising:
generating the geometric model of an object at a first workstation;
storing a first data representing the geometric model by the first workstation;
generating a duplicate copy of the first data by the first workstation;
transmitting via the communication network the duplicate copy and the commands to the second workstation;
receiving the modified duplicate copy of the first data from the second workstation; and
combining the first data and the modified duplicate copy of the first data to generate a modified geometric model of the object.

9. The method of claim 8, further comprising generating modification commands at the first workstation specifying portions of the first data to be modified by a second workstation, the modification commands specifying modifications so as to maintain a consistent representation of the geometric model, and transmitting the commands to the second workstation.

10. The method of claim 9, wherein the duplicate copy of the first data is modified by the second workstation in accordance with the modification commands so as to maintain a consistent representation of the geometric model.

11. The method of claim 8, further comprising creating a first data file containing the first data at the first workstation.

12. The method of claim 8, further comprising creating an output file at the first workstation, the output file containing the duplicate copy of the first data, and transmitting the output file to the second workstation.

13. The method of claim 8, further comprising reading an input file at the first workstation, the input file containing the modified duplicate copy of the first data.

14. The method of claim 13, further comprising storing modifications made by the second workstation to the duplicate copy of the first data in the input file.

15. A non-transitory computer-readable medium encoded with computer-executable instructions for allowing multiple users to collaboratively create and modify a geometric model of an object from separate workstations linked via a communication network, wherein the computer-executable instructions, when executed, cause at least one data processing system to:
generate the geometric model of an object;
store a first data representing the geometric model;
generate duplicate copies of the first data;
code operable to generate modification commands specifying portions of the first data to be modified by a second workstation, the modification commands specifying modifications so as to maintain a consistent representation of the geometric model;
transmit via the communication network the duplicate copy and the commands to the second workstation;
receive the modified duplicate copy of the first data from the second workstation; and
combine the first data and the modified duplicate copy of the first data to generate a modified geometric model of the object.

16. The computer-readable medium of claim 15, wherein the duplicate copy of the first data is modified by the second workstation in accordance with the modification commands so as to maintain a consistent representation of the geometric model by the first data and by the modified duplicate copy of the first data.

17. The computer-readable medium of claim 15, wherein the data processing system also creates a first data file containing the first data at the first workstation.

18. The computer-readable medium of claim 15, wherein the data processing system also creates an output file at the first workstation, the output file containing the duplicate copy of the first data.

19. The computer-readable medium of claim 18, wherein the data processing system also transmits the output file to the second workstation.

20. The computer-readable medium of claim 15, wherein the data processing system also creates an input file at the first workstation, the input file containing the modified duplicate copy of the first data, and stores modifications made by the second workstation to the duplicate copy of the first data in the input file at the first workstation.
